(19) United States
(12) Patent Application Publication
(10) Pub. No.: US 2019/0055499 A1
(43) Pub. Date: Feb. 21, 2019

(54) METHOD OF TREATING FABRICS

(71) Applicant: The Procter & Gamble Company, Cincinnati, OH (US)

(72) Inventors: Jef Annie Alfons MAES, Sint-Niklaas (BE); Jean-Francois BODET, Waterloo (BE); Neil Joseph LANT, Newcastle upon Tyne (GB); Robby Renilde Francois KEULEERS, Lippelo (BE)

(21) Appl. No.: 16/102,786

(22) Filed: Aug. 14, 2018

(30) Foreign Application Priority Data
Aug. 18, 2017 (WO) US2017/047497

(51) Int. Cl. C11D 3/39; C11D 3/386; C11D 3/00; C11D 1/83

(52) U.S. Cl. CPC C11D 3/3932; C11D 3/38636; C11D 11/0017; C11D 3/001; C11D 1/83; C11D 3/3942

(57) ABSTRACT

A method of treating fabrics including the steps of: providing a fabric comprising an ester containing compound pre-deposited thereon; and (ii) contacting the fabric with an aqueous medium comprising an acyl transferase enzyme and a peroxide source, wherein the acyl transferase enzyme causes generation of peracid in situ in the aqueous medium.

### REFERENCE TO A SEQUENCE LISTING

This application contains a Sequence Listing in computer readable form. The computer readable form is incorporated herein by reference.

### FIELD OF THE INVENTION

The present invention relates to a method of treating fabrics having an ester containing compound pre-deposited thereon, a fabric treatment kit comprising instructions, and use of an ester containing compound pre-deposited on fabrics as a bleach activator in a laundry wash process.

### BACKGROUND OF THE INVENTION

Bleach precursors such as peroxygen agents and bleach activators such as tetraacetylethylenediamine (TAED) and nonanoyloxybenzenesulfonate (NOBS) have been formulated together in laundry detergent compositions for chemical bleaching of stains found on both colored and white fabrics. The bleach activators react with the peroxygen agents upon contact with water to generate peracids (i.e. bleaching agent). Another way of producing peracid is to use an enzyme catalyst which is capable of catalysing a perhydrolysis reaction that results in the production of peracids from a carboxylic acid ester (acyl) substrate and a peroxide source.

However, prolonged storage of such detergent compositions in high humidity conditions often poses a risk of accidental premature activation of the formation of the bleaching agent, i.e. peracid. When activated, the bleaching agent may be consumed before it is contacts the water for washing and thus, is not present at the time of use for removing stains. In water-soluble unit dose pouches comprising the detergent composition, premature activation can also damage other ingredients present and/or cause packaging material of the unit dose pouches to deform in shape, or rupture thereby releasing the composition prior to use rendering the pouches unusable.

Accordingly, there remains a need for a method of treating fabrics with reduced risks of premature formation of peracids before use.

### SUMMARY OF THE INVENTION

The present invention relates to a method of treating fabrics comprising the steps of:
(i) Providing a fabric comprising an ester containing compound pre-deposited thereon; and
(ii) Contacting the fabric with an aqueous medium comprising an acyl transferase enzyme and a peroxide source, wherein the acyl transferase enzyme causes generation of peracid in situ in the aqueous medium.

The present invention also relates to a fabric treating kit comprising instructions for performing the method outlined above and at least one component selected from: a fabric treatment composition comprising an ester containing compound and a detergent composition comprising an acyl transferase enzyme and a peroxide source. The ester containing compound may be pre-deposited on a fabric through treating the fabric with the fabric treatment composition comprising the ester containing compound prior to contacting the fabric with an aqueous medium according to step (ii) of the method.

The present invention further relates to the use of an ester containing compound pre-deposited on a fabric as a bleach activator in a laundry wash process.

A technical effect of contacting the fabric with the ester containing compound pre-deposited thereon with the aqueous medium comprising the acyl transferase enzyme and the peroxide source is the acyl transferase enzyme catalyzes perhydrolysis of the ester containing compound by cleaving off one or more acyl groups of the ester containing compound which react with the peroxide source such as hydrogen peroxide, as shown in Equation 1 below, to form alcohol and peracid for bleaching. In Equation 1 below, perhydrolase is an example of an acyl transferase enzyme.

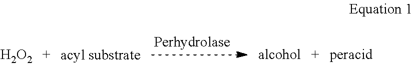

Having an ester source pre-deposited on a fabric allows peracid to be formed in situ during a washing machine cycle through a reaction between the ester containing compound pre-deposited on the fabric as the acyl substrate and the acyl transferase enzyme and the peroxide source. This can eliminate the need to formulate an acyl substrate in a detergent composition for bleaching. As there is no acyl substrate in the detergent composition, this eliminates the risk of premature reaction of an acyl substrate, a corresponding enzyme and the peroxide source within the detergent composition and enables the detergent composition to be provided in a stable form suitable for storage. Further, there is more formulation space for other actives to be added in detergent compositions such as a unit dose package for delivery of other benefits in fabric treatment with less likelihood of chemical or physical incompatibilities of the actives.

### DETAILED DESCRIPTION OF THE INVENTION

The present invention relates to a method of treating fabrics comprising the steps of:
(i) Providing a fabric comprising an ester containing compound pre-deposited thereon; and
(ii) Contacting the fabric from step (i) with an aqueous medium comprising an acyl transferase enzyme and a peroxide source, wherein the acyl transferase enzyme causes generation of peracid in situ in the aqueous medium.

Prior to describing the present invention in detail, the following terms are defined for clarity. Terms not defined should be given their ordinary meaning as understood by a skilled person in the relevant art.

As used herein, the term “transferase” refers to an enzyme that catalyzes the transfer of a functional group from one substrate to another substrate. For example, an acyl transferase may transfer an acyl group from an acyl substrate to a hydrogen peroxide substrate to form a peracid.

As used herein, the term “ester containing compound” refers to a compound comprising one or more acyl groups and the compound may comprise the following structure:

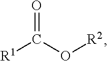

wherein:
R1 and R2 are selected from the group of substituted or unsubstituted saturated or unsaturated alkyl chains, substituted or unsubstituted cycloalkyl, and substituted or unsubstituted aryl, preferably selected from the group of substituted or unsubstituted saturated or unsaturated alkyl chains.

As used herein, the term “bleach activator” refers to an active capable of being utilized as an acyl transferase enzyme substrate and reacting with a peroxide source for generation of peracids.

As used herein, the term “peroxide source” refers to a molecule capable of generating hydrogen peroxide. Hydrogen peroxide sources include hydrogen peroxide, itself, as well as molecules that spontaneously, enzymatically, or chemically catalytically produce hydrogen peroxide as a reaction product. Such molecules include, e.g., perborate and percarbonate.

As used herein, the term ‘liquid laundry detergent composition’ refers to any laundry detergent composition comprising a liquid capable of wetting and treating a fabric, and includes, but is not limited to, liquids, gels, pastes, dispersions and the like. The liquid composition can include solids or gases in suitably subdivided form, but the liquid composition excludes forms which are non-fluid overall, such as tablets or granules.

The ester containing compound pre-deposited on the fabric can act as an acyl substrate for the acyl transferase enzyme. As a result, peracids can be generated in situ, preventing premature reactions in the detergent and beyond securing it is still alive during the washing machine cycle. Also, the method allows for a second use of actives which otherwise would just be washed away.

As the in-situ generated peracids are produced, the peracids bleach coloured stains on the fabrics in an aqueous environment, thereby cleaning stains on the fabrics.

The above method reduces or obviates many problems associated with conventional bleaching methods which use detergent compositions in which the acyl substrate, the peroxide source and the acyl transferase enzyme are contained within the detergent compositions.

Having an ester containing compound pre-deposited on the fabric and the higher concentration of the ester compound pre-deposited thereon improves peracid generation as it will speed up reaction kinetics and increases the amount of possible peracid molecules to be formed. Meanwhile, the acyl transferase enzyme acts as a catalyst and will continuously be re-generated.

The method of the present invention comprises a step (i) of providing a fabric comprising an ester containing compound pre-deposited thereon. Preferably, the ester containing compound is pre-deposited onto the fabric in a pre-treatment step prior to step (i). An advantage of applying the ester containing compound prior to step (i) is to enable selective treatment of fabric articles containing stains which require removal by bleaching.

The pre-treatment step may comprise washing and/or conditioning the fabric in an aqueous medium comprising the ester-containing compound in a washing machine cycle. The washing machine cycle may comprise one or more cycles depending on the design of the washing machine including but not limited to, a wash cycle, a rinse cycle. For example, the aqueous medium may be formed in a wash cycle of a previous machine wash operation. The aqueous medium may be formed in a rinse cycle of a previous machine wash operation. The aqueous medium may also be formed in a manual wash cycle. The fabric may be wet or subsequently dried after the wash cycle.

Alternatively, the pre-treatment step may comprise spraying a liquid composition comprising the ester containing compound on the fabric through a trigger, aerosol or foam spray device. Alternatively, the pre-treatment step may comprise immersing the fabric in a liquid composition comprising the ester containing compound.

The ester containing compound may be selected from the group consisting of fabric softening ester compounds, perfume ester compounds, and mixtures thereof. Preferably the ester containing compound comprises fabric softening ester compounds, and mixtures thereof.

The ester containing compound pre-deposited on the fabrics may be a fabric softening ester containing compound (hereinafter, “fabric softening active”), having been deposited on the fabrics by use of a fabric softening composition in a previous wash cycle. An environmental advantage of the present invention is that it recycles the fabric softening active which was deposited on the fabric for softness in the previous wash for a secondary use as a bleach activator in the formation of peracid for bleaching of the fabric.

Suitable ester based fabric softening actives, include, but are not limited to, materials selected from the group consisting of quaternary ammonium ester compounds, sucrose esters, ester amines, fatty esters, and combinations thereof. An advantage is such fabric softening actives have a high affinity to fabrics for delivering a softening benefit, and provides product weight efficiency, and sensitivity to other enzymes during manufacturing.

Fabric softening actives may be selected from the group consisting of quaternary ammonium ester compounds (ester quats) and mixtures thereof. Suitable quaternary ammonium ester compounds (ester quats) include but are not limited to, materials selected from the group consisting of ester quats, amidoester quats and combinations thereof, preferably ester quats. Suitable ester quats include but are not limited to, materials selected from the group consisting of monoester quats, diester quats, triester quats and combinations thereof. An advantage of ester quats is the ester groups, when cleaved off by the enzyme, are substantially odorless.

The fabric softening actives may be selected from the group consisting of diester quats and mixtures thereof. Most preferably, the fabric softening active may comprise Diethylester Dimethyl Ammonium Chloride (DEEDMAC). A di-ester quat may have the following general structure.

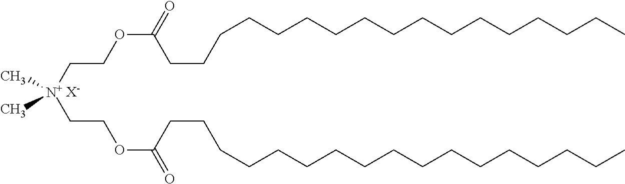

Each diesterquat molecule will create two peracids given there are two ester bonds that can be cleaved by the enzyme. Further, the two long chain alkyl chains of diester quats enable high fabric pre-deposition efficiency, and therefore are preferred for used as fabric softener actives in fabric softening rinse compositions.

The iodine value (“IV”) of the parent fatty acyl compound or acid from which the alkyl or, alkenyl chains are derived is preferably from 0 to 60, 12 to 58, or 18 to 56. If there is any unsaturated quaternary ammonium compound present in the composition, the iodine value, referred to above, represents the mean iodine value of the parent fatty acyl compounds or fatty acids of all of the quaternary ammonium compound present.

Examples of suitable commercially quaternary ammonium ester fabric softening actives are available from KAO Chemicals under the trade name Tetranyl AT-1 and Tetranyl AT-7590, from Evonik under the tradename Rewoquat WE16 DPG, Rewoquat WE18, Rewoquat WE20, Rewoquat WE28, and Rewoquat 38 DPG, from Stepan under the tradename Stepantex GA90, Stepantex VR90, Stepantex VK90, Stepantex VA90, Stepantex DC90, Stepantex VL90A.

In the cationic nitrogenous salts herein, the anion X—, which comprises any softener compatible anion, provides electrical neutrality. Most often, the anion used to provide electrical neutrality in these salts is from a strong acid, especially a halide, such as chloride, bromide, or iodide. However, other anions can be used, such as methylsulfate, ethylsulfate, acetate, formate, sulfate, carbonate, fatty acid anions and the like. Preferably, the anion X— may comprise chloride or methylsulfate. The anion may carry a double charge, wherein X— represents half a group.

A suitable ester quat may be the reaction product of methyl-diethanolamine with fatty acids, in molar ratio ranging from 1:1.5 to 1:2, fully or partially quaternized with methylchloride or dimethylsulphate. The ester quat may be the reaction product of tri-ethanolamine with fatty acids, mixed in a molar ratio ranging from 1:1.5 to 1:2.1, fully or partially quaternized with dimethylsulphate. A suitable ester quat may be the reaction product of methyl-diethanolamine with fatty acids, fully or partially quaternized with dimethylsulphate. Another suitable ester quat may be the reaction product of methyldi-isopropanolamine with fatty acids, in molar ratio ranging from 1:1.5 to 1:2, fully or partially quaternized with dimethylsulphate. In these four cases, the fatty acid contains 8-24 carbon atoms.

The fluid fabric softening active may be a sucrose ester. Sucrose esters are typically derived from sucrose and fatty acids. Sucrose ester is composed of a sucrose moiety having one or more of its hydroxyl groups esterified. Sucrose is a disaccharide having the following formula:

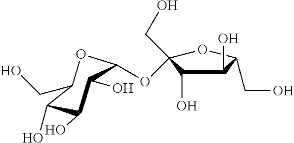

Alternatively, the sucrose molecule can be represented by the formula: M(OH)₈, wherein M is the disaccharide backbone and there are total of 8 hydroxyl groups in the molecule.

Thus, sucrose esters can be represented by the following formula:

M(OH)₈₋ₓ(OC(O)R¹)ₓ

wherein x is the number of hydroxyl groups that are esterified, whereas (8-x) is the hydroxyl groups that remain unchanged; x is an integer selected from 1 to 8, alternatively from 2 to 8, alternatively from 3 to 8, or from 4 to 8; and R¹ moieties are independently selected from C₁-C₂₂ alkyl or C₁-C₃₀ alkoxy, linear or branched, cyclic or acyclic, saturated or unsaturated, substituted or unsubstituted.

The R¹ moieties may comprise linear alkyl or alkoxy moieties having independently selected and varying chain length. For example, R¹ may comprise a mixture of linear alkyl or alkoxy moieties wherein greater than 20% of the linear chains are C₁₈, alternatively greater than 50% of the linear chains are C₁₈, alternatively greater than 80% of the linear chains are C₁₈.

The R¹ moieties may comprise a mixture of saturate and unsaturated alkyl or alkoxy moieties. The iodine value (IV) of the sucrose esters suitable for use herein ranges from 1 to 150, or from 2 to 100, or from 5 to 85. The R¹ moieties may be hydrogenated to reduce the degree of unsaturation. In the case where a higher IV is preferred, such as from 40 to 95, then oleic acid and fatty acids derived from soybean oil and canola oil are suitable starting materials.

The unsaturated R¹ moieties may comprise a mixture of “cis” and “trans” forms the unsaturated sites. The “cis”/“trans” ratios may range from 1:1 to 50:1, or from 2:1 to 40:1, or from 3:1 to 30:1, or from 4:1 to 20:1.

Alternative suitable ester containing amines include but are not limited to, materials selected from the group consisting of ester amines, amidoester amines, and combinations thereof, preferably ester amines and mixtures thereof. Suitable ester amines include but are not limited to, materials selected from the group consisting of monoester amines, diester amines, triester amines and combinations thereof.

Alternatively the fluid fabric softening active may be an ester containing softening oil, e.g. fatty esters (such as glycerol monostearate and glycerol distearate), and fatty ester amines.

Alternatively the ester compound may be a perfume ester compound, typically selected from the list of 2-methyl butyl 3-methyl butenoate, 2-T-BUTYL CYCLOHEXYL ACETATE, ALLYL ACETATE, ALLYL AMYL GLYCOLATE, ALLYL CAPROATE, allyl cyclohexyl acetate, allyl cyclohexyl butyrate, BENZYL ACETATE, CIS-3-HEXENYL BENZOATE, CIS-3-HEXENYL SALICYLATE, Citronellyl (R)-Lactate, CITRONELLYL ACETATE, CITRONELLYL CAPROATE, CYCLOHEXYL ETHYL ACETATE, DIHYDRO TERPINYL ACETATE, DIMETHYL BENZYL CARBINYL BUTYRATE, DIMETHYL BENZYL CARBINYL PROPIONATE, ETHYL 2 METHYL PENTANOATE, ETHYL CINNAMATE, Ethyl Linalyl Acetate, Ethyl Linalyl Acetate, ETHYL LINOLEATE, Ethyl Phenyl Acetate, ETHYL SAFRANATE, ETHYL SORBATE, Eugenyl Acetate, FLOR ACETATE, FRUITATE, GERANYL BUTYRATE, GERANYL CAPROATE, GERANYL ISOBUTYRATE, HEXYL ACETATE, HEXYL CINNAMATE, HEXYL ISOBUTYRATE, Hexyl propionate, HEXYL SALICYLATE, ISO BUTYL SALICYLATE, ISO EUGENOL ACETATE, ISO NONYL ACETATE, Isoamyl salicylate, ISO BORNYL ACETATE, LINALYL ACETATE, LINALYL ISO BUTYRATE, MENTHYL ACETATE 620020, METHYL BENZOATE, METHYL CINNAMATE, METHYL DIHYDRO JASMONATE, METHYL LINOLEATE, METHYL PAMPLEMOUSSE, METHYL PHENYL CARBINYL ACETATE, NERYL PROPIONATE, NOPYL ACETATE, PARA CRESYL CAPRYLATE, Para Cresyl Phenyl Acetate, PHENYL ETHYL ACETATE, PHENYL ETHYL ISO BUTYRATE, PSEUDO LINALYL ACETATE, TERPINYL ACETATE, Tetrahydro Geranyl Acetate, TETRAHYDRO LINALYL ACETATE, THESARON, and mixtures thereof.

Preferably the pre-deposited perfume ester compound is selected from ALLYL

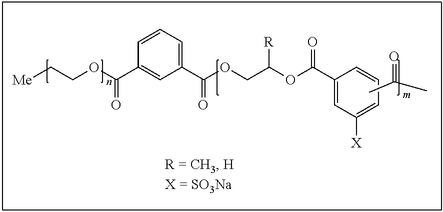

CAPROATE, BENZYL ACETATE, CIS-3-HEXENYL SALICYLATE, CITRONELLYL ACETATE, FLOR ACETATE, HEXYL ACETATE, HEXYL SALICYLATE, LINALYL ACETATE, METHYL PHENYL CARBINYL ACETATE, TERPINYL ACETATE, and mixtures thereof.

Further, the ester containing compounds may comprise ester based soil release polymers present in liquid detergents wherein the ester based soil release polymers are selected for reactivity with the enzyme. The soil-release polymer(s) present in the composition of the present invention preferably comprise terephthalate ester moieties and more preferably represents a copolymer comprising terephthalate ester moieties. Even more preferably the soil release compound may represent a copolyester comprising terephthaloyl, alkylene glycol and polyalkylene glycol units. The copolymer further may comprise monomeric units substituted with anionic groups, such as for example sulfonated isophthaloyl units. Even more preferably the soil-release polymer of the present invention may represent a copolymer comprising polyethylene terephthalate and polyoxyethylene terephthalate blocks. Particularly preferred soil release polymers be copolymers having random blocks of polyethylene terephthalate (PET) and polyethylene oxide terephtalate (PEOT). Suitable polymers are commercially available under the trademark names of Marloquest L235M or Marloquest HSCB (Sasol, Johannesburg, South Africa), Texcare SRN 170, Texcare SRN 172 or Texcare SRA300 F (Clariant, Muttenz, Switzerland) and Repelotex Crystal (Rhodia, La Défense, France). A soil release polymer commercially under the trademark name of Texcare SRA300 F (Clariant, Muttenz, Switzerland) may comprise a general structure shown below:

The pre-deposited ester compound may be an ester based softening compound pre-deposited on the fabrics during a preceding wash process, the ester based softening compound having been released to the fabrics by exposing a fabric conditioning composition to the fabric during the rinse cycle.

The method of the present invention may comprise a step (ii) of contacting the fabric comprising an ester containing compound deposited thereon with an aqueous medium comprising an acyl transferase enzyme and a peroxide source, wherein the acyl transferase enzyme causes generation of peracid in situ in the aqueous medium.

The aqueous medium may comprise between 0.05 and 10 ppm of the acyl transferase enzyme. An advantage of the above concentration of acyl transferase enzyme is that lower levels outside of the above concentration may cause reaction speeds which are too low and thereby resulting in insufficient peracid formation for decent cleaning performance. On the other hand, higher levels outside of the above concentration may incur unnecessary cost of providing the enzymes. Further an enzyme level is typically constrained by safety i.e. prevention of sensitization risk during manufacturing.

The acyl transferase enzyme may comprise a perhydrolase enzyme. One or more perhydrolase enzymes may be used in the compositions according to the methods described herein. Specifically, perhydrolase enzymes are enzymes capable of generating peracids in the presence of a suitable acyl substrate and hydrogen peroxide. Examples of a perhydrolase enzyme are set out below. The perhydrolase enzyme may comprise naturally-occurring enzymes (i.e., a perhydrolase enzyme encoded by a genome of a cell). The perhydrolase enzyme may comprise, consists of, or consists essentially of an amino acid sequence that is at least about 80%, 85%, 90%, 95%, 97%, 98%, 99%, or 99.5% identical to the amino acid sequence of a naturally-occurring perhydrolase enzyme.

The perhydrolase enzyme may be a naturally-occurring Mycobacterium smegmatis perhydrolase enzyme as disclosed as set forth in SEQ ID NO: 1. The perhydrolase enzyme may comprise, consists of, or consists essentially of the amino acid sequence set forth in SEQ ID NO:1 or a variant or homologue thereof. The perhydrolase enzyme may comprise, consists of, or consists essentially of an amino acid sequence that is at least about 80%, 85%, 90%, 95%, 97%, 98%, 99%, or 99.5% identical to the amino acid sequence set forth in SEQ ID NO:1.

The perhydrolase enzyme comprises one or more substitutions at one or more amino acid positions equivalent to position(s) in the M. smegmatis perhydrolase amino acid sequence set forth in SEQ ID NO:1. The perhydrolase enzyme may comprise any one or any combination of substitutions of amino acids selected from M1, K3, R4, IS, L6, C7, D10, S11, L12, T13, W14, W16, G15, V17, P18, V19, D21, G22, A23, P24, T25, E26, R27, F28, A29, P30, D31, V32, R33, W34, T35, G36, L38, Q40, Q41, L42, G43, A44, D45, F46, E47, V48, I49, E50, E51, G52, L53, S54, A55, R56, T57, T58, N59, I60, D61, D62, P63, T64, D65, P66, R67, L68, N69, G70, A71, S72, Y73, S76, C77, L78, A79, T80, L82, P83, L84, D85, L86, V87, N94, D95, T96, K97, Y99, F100, R101, R102, P104, L105, D106, I107, A108, L109, G110, M111, S112, V113, L114, V115, T116, Q117, V118, L119, T120, 5121, A122, G124, V125, G126, T127, T128, Y129, P146, P148, W149, F150, I153, F154, I194, and F196.

The perhydrolase enzyme may comprise one or more of the following substitutions at one or more amino acid positions equivalent to position(s) in the M. smegmatis perhydrolase amino acid sequence set forth in SEQ ID NO:1: L12C, Q, or G; T25S, G, or P; L53H, Q, G, or S; S54V, L A, P, T, or R; A55G or T; R67T, Q, N, G, E, L, or F; K97R; V125S, G, R, A, or P; F154Y; F196G.

The perhydrolase enzyme may comprise the S54V variant of SEQ ID NO: 1, which is commercially available and set forth as SEQ ID NO: 2.

The perhydrolase enzyme may comprise a combination of amino acid substitutions at amino acid positions equivalent to amino acid positions in the M. smegmatis perhydrolase amino acid sequence set forth in SEQ ID NO:1: L121 S54V; L12M S54T; L12T S54V; L12Q T25S S54V; L53H S54V; S54P V125R; S54V V125G; S54V F196G; S54V K97R V125G; or A55G R67T K97R V125G.

The perhydrolase may comprise a variant of so-called CE-7 perhydrolases disclosed in WO2010/039958 (Du Pont). The CE-7 enzyme family includes cephalosporin C deacetylases (CAHs; E. C. 3.1.1.41) and acetyl xylan esterases (AXEs; E. C. 3.1.1.72). Members of the CE-7 enzyme family share a conserved signature motif (Vincent et al., J, Mol. Biol., 330:593-606 (2003)). As used herein, the terms “signature motif”, “CE-7 signature motif”, and “diagnostic motif” refer to conserved structures shared among a family of enzymes having a defined activity. The signature motif can be used to define and/or identify the family of structurally related enzymes having similar enzymatic activity for a defined family of substrates. The signature motif can be a single contiguous amino acid sequence or a collection of discontiguous, conserved motifs that together form the signature motif. Typically, the conserved motif(s) is represented by an amino acid sequence. The present variant enzymes having perhydrolysis activity (“perhydrolases”) belong to the family of CE-7 carbohydrate esterases (i.e., all of the present variants retain the CE-7 signature motif).

As used herein, “structurally classified as a CE-7 enzyme”, “structurally classified as a carbohydrate esterase family 7 enzyme”, “structurally classified as a CE-7 carbohydrate esterase”, and “CE-7 perhydrolase” will be used to refer to enzymes having perhydrolysis activity that are structurally classified as a CE-7 carbohydrate esterase based on the presence of the CE-7 signature motif (Vincent et al., vide supra).

As used herein, the terms “cephalosporin C deacetylase” and “cephalosporin C acetyl hydrolase” refer to an enzyme (E. C. 3.1.1.41) that catalyzes the deacetylation of cephalosporins such as cephalosporin C and 7-aminocephalosporanic acid (Mitsushima et al., (1995) Appl. Env. Microbiol. 61 (6):2224-2229).

As used herein, “acetyl xylan esterases” refers to an enzyme (E. C. 3.1.1.72; AXEs) that catalyzes the deacetylation of acetylated xylans and other acetylated saccharides.

As used herein, the term “Thermotoga neapolitana” refers to a strain of Thermotoga neapolitana reported to have acetyl xylan esterase activity (GENBANK® AAB70869). The amino acid sequence of the enzyme having perhydrolase activity from Thermotoga neapolitana is provided as SEQ ID NO: 3.

As used herein, the term “Thermotoga maritima” refers to a bacterial cell reported to have acetyl xylan esterase activity (GENBANK® NP_227893.1). The amino acid sequence of the enzyme having perhydrolase activity from Thermotoga maritima is provided as SEQ ID NO: 4.

As used herein, the term ‘Thermotoga lettingae” refers to a bacterial cell reported to have acetyl xylan esterase activity (GENBANK® CP000812). The deduced amino acid sequence of the enzyme having perhydrolase activity from Thermotoga lettingae is provided as SEQ ID NO: 5.

As used herein, the term “Thermotoga petrophila” refers to a bacteria! cell reported to have acetyl xylan esterase activity (GENBANK® CP000702). The deduced amino acid sequence of the enzyme having perhydrolase activity from Thermotoga lettingae is provided as SEQ ID NO: 6.

As used herein, the term “Thermotoga sp. RQ2” refers to a bacterial cell reported to have acetyl xylan esterase activity (GENBANK® CP000969). Two different acetyl xylan esterases have been identified from Thermotoga sp. RQ2 and are referred to herein as “RQ2(a)” (the deduced amino acid sequence provided as SEQ ID NO: 7) and BRQ2(b)” (the deduced amino acid sequence provided as SEQ ID NO: 8).

The perhydrolase may comprise variants of wild-type subtilisin Carlsberg possessing perhydrolase activity such as those disclosed in DE10260903 (Henkel) and US2007/0128129 (Henkel).

Different perhydrolase enzymes exhibit differences in activity as a function of formulation and washing condition, including relative perhydrolysis to hydrolysis activity. Those skilled in the formulation of laundry detergents would be able to select optimal enzyme(s) for a particular formulation/condition.

Typically, the perhydrolase enzyme is formulated to achieve wash concentrations of between 0.01 and 10 ppm.

For purposes of the present invention, the degree of sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 3.0.0 or later. The optional parameters used are gap open penalty of 10, gap extension penalty of 0.5, and the EBLOSUM62 (EMBOSS version of BLOSUM62) substitution matrix. The output of Needle labeled “longest identity” (obtained using the nobrief option) is used as the percent identity and is calculated as follows:

(Identical Residues×100)/(Length of Alignment−Total Number of Gaps in Alignment).

The aqueous medium further includes at least one peroxide source. A preferred peroxide is hydrogen peroxide.

The peroxide source may be a compound that generates peroxide upon addition to water. The compound may be a solid or a liquid. Such compounds include adducts of hydrogen peroxide with various inorganic or organic compounds, of which the most widely employed is sodium carbonate perhydrate, also referred to as sodium percarbonate.

The peroxide source may be an inorganic perhydrate salt. Examples of inorganic perhydrate salts are perborate, percarbonate, perphosphate, persulfate and persilicate salts. Inorganic perhydrate salts are normally alkali metal salts. Inorganic perhydrate salts have a higher chemical stability especially peroxygen stability of inorganic perhydrate salts compared to hydrogen peroxide. Specifically, there is a higher chemical stability compared to enzymatic systems formulated with hydrogen peroxide when formulating the pH of a neutral to alkaline finished product.

Additional hydrogen peroxide sources include adducts of hydrogen peroxide with zeolites, urea hydrogen peroxide, and carbamide peroxide.

The peroxide source may be in a crystalline form and/or substantially pure solid form without additional protection. For certain perhydrate salts, preferred forms are granular compositions involving a coating, which provides better storage stability for the perhydrate salt in the granular product. Suitable coatings comprise inorganic salts such as alkali metal silicate, carbonate or borate salts or mixtures thereof, or organic materials such as waxes, oils, or fatty soaps.

Preferably, the peroxide source is an inorganic perhydrate salt, such as, for example, percarbonate.

Alternatively, the peroxide source may be an enzymatic peroxide generation system. The enzymatic hydrogen peroxide generation system may comprise an oxidase and its substrate. Suitable oxidase enzymes include, but are not limited to: glucose oxidase, sorbitol oxidase, hexose oxidase, choline oxidase, alcohol oxidase, glycerol oxidase, cholesterol oxidase, pyranose oxidase, carboxyalcohol oxidase, L-amino acid oxidase, glycine oxidase, pyruvate oxidase, glutamate oxidase, sarcosine oxidase, lysine oxidase, lactate oxidase, vanillyl oxidase, glycolate oxidase, galactose oxidase, uricase, oxalate oxidase, and xanthine oxidase. The following equation provides an example of a coupled system for enzymatic production of hydrogen peroxide:

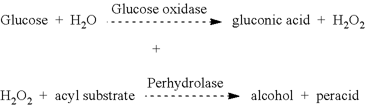

It is not intended that the generation of peroxide be limited to any specific enzyme, as any enzyme that generates peroxide with a suitable substrate may be used. For example, lactate oxidases from Lactobacillus species known to create peroxide from lactic acid and oxygen may be used. One advantage of such a reaction is the enzymatic generation of acid {e.g., gluconic acid in the above example), which reduces the pH of a basic aqueous solution to within the pH range in which peracid is most effective in bleaching {i.e., at or below the pKa). Such a reduction in pH is also brought about directly by the production of peracid. Other enzymes (e.g., alcohol oxidase, ethylene glycol oxidase, glycerol oxidase, amino acid oxidase, etc.) that are capable of generating hydrogen peroxide may also be used with acyl substrates in combination with a perhydrolase enzyme to generate peracids.

Where a coupled system for enzymatic production of hydrogen peroxide is used, the oxidase enzyme is preferably provided in a different compartment in the unit dose package than the substrate for the oxidase, or the oxidase and substrate should be provided in non-mixing forms such that they do not react until the detergent has been exposed to water.

The peroxide source may be provided as a liquid at low pH, e.g., a pH less than about 6.5, less than about 6.0, less than about 5.5, less than about 5.0, less than about 4.5, or even less than about 4.0, to stabilise the peroxide source against degradation.

The peroxide source may be provided in a molar excess with respect to the perhydrolase enzyme. The molar ratio of hydrogen peroxide to perhydrolase enzyme may be at least about 100/1, preferably at least about 1000/1, more preferably at least about 10,000/1.

The concentration of peroxygen compound in the aqueous medium may range from about 0.01 wt % to about 30 wt, preferably from about 0.1 wt % to about 20 wt, more preferably from about 0.5 wt % to about 10 wt %, most preferably from about 1 wt % to about 5 wt %.

Preferably, the aqueous medium is prepared by diluting a laundry detergent composition, preferably a liquid laundry detergent composition in water wherein the laundry detergent composition comprises the acyl transferase enzyme and the peroxide source. The aqueous medium may be prepared by diluting a laundry detergent composition in water, wherein the laundry detergent composition comprises the acyl transferase enzyme, the peroxide source, and less than 1%, preferably less than 0.5%, more preferably less than 0.1%, by weight of the laundry detergent composition of an additional acyl substrate. A risk of peracid formation in the laundry detergent composition during storage or prior to use in a laundry wash process may be minimized.

The temperature of the aqueous medium may be between 20 degrees Celsius to 50 degrees Celsius, preferably between 25 degrees Celsius to 40 degrees Celsius.

Having the temperature in the above range ensures stability of the enzyme and/or the peroxide source in the aqueous medium. This is because enzyme stability may be challenged at higher temperatures and therefore there may be a risk of no peracid formation as the enzyme may be killed at higher temperatures outside of the above ranges. Similarly, stability of the peroxide source may also be affected by temperatures higher than the above ranges as the peroxide source may thermally decompose at higher temperatures outside of the above ranges. Lower temperatures outside of the above ranges may comprise cleaning kinetics.

A laundry detergent composition is any detergent suitable to be used in a fabric laundering operation. The laundry detergent composition may be in the form of a powder, a liquid or a mixture thereof. Most preferably the laundry detergent is a water-soluble unit dose article comprising a liquid laundry detergent and a water-soluble film. Unit dose articles may be used to contain incompatible materials such as the acyl transferase enzyme and perfumes comprising ester raw materials, or other eventually formulated acyl substrates by separating the materials in different compartments within the same unit dose article to minimize a risk of premature peracid formation.

The laundry detergent composition may comprise between 0.0001% and 1%, preferably between 0.001% and 0.2%, more preferably between 0.005% and 0.1% by weight of the laundry detergent composition of the acyl transferase enzyme.

The laundry detergent composition may comprise between 0.1% and 10%, preferably between 0.5% and 7%, more preferably between 0.75% and 5% even more preferably between 1% and 4%, most preferably between 1.25% and 3% by weight of the laundry detergent composition of the peroxide source.

The laundry detergent composition may comprise the acyl transferase enzyme, the peroxide source, and 0.05% to 40%, preferably 0.1% to 20%, more preferably 0.5% to 10%, most preferably 1% to 5%, by weight of the laundry detergent composition of an additional acyl substrate, wherein the additional acyl substrate is substantially free of esters found in perfume ester compounds. The above composition may result in increased kinetics of peracid creation in situ, and generating higher concentration of peracid in the washing liquor for cleaning.

The laundry detergent composition may comprise between 10% and 60%, preferably between 15% and 55%, more preferably between 20% and 50%, most preferably between 25% and 45% by weight of the laundry detergent composition of a surfactant system. The surfactant system will strip the pre-deposited ester-containing compound from the fabric so as to facilitate generation of peracids.

Preferably, the surfactant system comprises a non-soap surfactant. Preferably, the surfactant system comprises an anionic surfactant and optionally a non-ionic surfactant. More preferably, the weight ratio of anionic surfactant to non-ionic surfactant is from 1:2 to 20:1, preferably from 1:1 to 15:1, more preferably from 1.5:1 to 10:1, most preferably from 5:1 to 10:1.

The non-soap anionic surfactant is preferably selected from sulphate or sulphonate anionic surfactants or mixtures thereof, preferably linear alkylbenzene sulphonate, alkyl sulphate, alkoxylated alkyl sulphate or a mixture thereof. Preferably, the alkoxylated alkyl sulphate is an ethoxylated alkyl sulphate preferably with an average degree of ethoxylation of between 0.5 and 4, between 1 and 4, between 2 and 4, or about 3.

Preferably, the weight ratio of linear alkylbenzene sulphonate to alkoxylated alkyl sulphate is between 15:1 and 1:3, 10:1 and 1:2, 5:1 and 1:1, 3:1 and 1:1, or 2:1 and 1:1.

The non-ionic surfactant may be selected from a fatty alcohol alkoxylate, an oxosynthesised fatty alcohol alkoxylate, Guerbet alcohol alkoxylates, alkyl phenol alcohol alkoxylates, alkyl polyglucoside or a mixture thereof. Preferably, the non-ionic surfactant comprises a fatty alcohol ethoxylate non-ionic surfactant. Even more preferably the nonionic surfactant consists of a fatty alcohol ethoxylate surfactant.

Suitable fatty alcohol ethoxylate nonionic surfactants include the condensation products of aliphatic alcohols with from 1 to 25 moles of ethylene oxide. The alkyl chain of the aliphatic alcohol can either be straight or branched, guerbet, primary or secondary, and generally contains from 8 to 22 carbon atoms. The starting alcohol can be naturally derived, e.g. starting from natural oils, or synthetically derived, e.g. alcohols obtained from for example oxo-, modified oxo- or Fischer-Tropsch processes. Examples of oxo-process derived fatty alcohols include the Lial and Isalchem 5 fatty alcohols ex Sasol company and Lutensol fatty alcohols ex BASF company.

Examples of modified-oxo process derived fatty alcohols include the Neodol fatty alcohols ex Shell company. Fischer-Tropsch derived fatty alcohols include Safol fatty alcohols ex Sasol company. The alkoxylate chain of fatty alcohol ethoxylates is made up solely of ethoxylate groups. Preferably, the fatty alcohol ethoxylate non-ionic surfactant comprises on average 10 between 8 and 18, more preferably between 10 and 16 even more preferably between 12 and 15 carbon atoms in the alcohol carbon chain, and on average between 5 and 12, preferably between 6 and 10, more preferably between 7 and 8 ethoxy units in the ethoxylation chain. Preferably, the weight ratio of linear alkylbenzene sulphonate to non-ionic surfactant is between 2:1 to 20:1 preferably 2:1 and 10:1; more preferably 5:1 and 10:1.

Preferably, the weight ratio of alkoxylated alkyl sulphate to non-ionic surfactant is between 2:1 and 20:1 preferably between 2:1 and 10:1 more preferably between 2:1 and 5:1. Preferably, the weight ratio of linear alkylbenzene sulphonate to fatty alcohol ethoxylate non-ionic surfactant is between 2:1 to 20:1 preferably 2:1 and 10:1; more preferably 5:1 and 10:1. Preferably, the weight ratio of alkoxylated alkyl sulphate to fatty alcohol ethoxylate nonionic surfactant is between 2:1 and 20:1 preferably between 2:1 and 10:1 more preferably between 2:1 and 5:1.

The liquid laundry detergent composition may comprise a further polymer, preferably selected from alkoxylated, preferably ethoxylated polyethyleneimine, alkoxylated polyalkyl phenol, a polyester terephthalate, hydroxyethylcellulose, preferably quaternized hydroxyethylcellulose, a carboxymethylcellulose or a mixture thereof.

The liquid laundry detergent composition may comprise an adjunct material, wherein the adjunct material is preferably selected from cleaning polymers, soil suspension polymers, surface modifying polymers, builders, chelants, dispersants, enzymes, enzyme stabilizers, catalytic materials, bleach, bleach activators, polymeric dispersing agents, anti-redeposition agents, suds suppressors, aesthetic dyes, opacifiers, perfumes, perfume delivery systems, structurants, hydrotropes, rheology modifiers, processing aids, pigments and mixtures thereof. Having an adjunct material in the composition provides good overall cleaning, soil suspension and whiteness or colour brightness profile of the fabric to be treated.

Preferably, the water-soluble unit dose article comprises 15% or less by weight of the unit dose article of water, preferably the unit dose article comprises between 0.1% and 15%, more preferably between 1% and 12.5% by weight of the unit dose article of water.

The liquid laundry detergent composition preferably has a pH from 6 to 10 preferably from 7 to 9, more preferably from 7 to 8, preferably wherein the liquid laundry detergent composition comprises a pH adjusting agent selected from alkanolamines, preferably monethanolamine, diethanolamine, triethanolamine or a mixture thereof, most preferably monoethanolamine.

Those skilled in the art will know how to make the laundry detergent composition using known techniques.

The detergent composition optionally further comprises an additional acyl substrate, such as for example, a carboxylic acid ester (acyl) substrate, which is perhydrolyzed by the perhydrolase enzyme in the presence of the peroxide source to generate peracids.

The acyl substrate may be an ester of an aliphatic and/or aromatic carboxylic acid or alcohol. The acyl substrate may be a mono-, di-, tri-, or multivalent ester, or a mixture thereof. For example, the acyl substrate may be a carboxylic acid and a single alcohol (monovalent, e.g., ethyl acetate, propyl acetate), two carboxylic acids and a diol [e.g., propylene glycol diacetate (PGDA), ethylene glycol diacetate (EGDA), or a mixture, for example, 2-acetyloxy 1-propionate, where propylene glycol has an acetate ester on alcohol group 2 and a propyl ester on alcohol group 1], or three carboxylic acids and a triol {e.g., glycerol triacetate or a mixture of acetate/propionate, etc., attached to glycerol or another multivalent alcohol).

The acyl substrate may be an ester of a nitroalcohol {e.g., 2-nitro-1-propanol).

The acyl substrate may be a polymeric ester, for example, a partially acylated (acetylated, propionylated, etc.) poly carboxy alcohol, acetylated starch, etc.

The acyl substrate may be an ester of one or more of the following: formic acid, acetic acid, propionic acid, butyric acid, valeric acid, caproic acid, caprylic acid, nonanoic acid, decanoic acid, dodecanoic acid, myristic acid, palmitic acid, stearic acid, oleic acid, monoacetin, monopropionin, dipropionin, tripropionin, monobutyrin, dibutyrin, glucose pentaacetate, xylose tetraacetate, acetylated xylan, acetylated xylan fragments, P-D-ribofuranose-1,2,3,5-tetraacetate, tri-O-acetyl-D-galactal, tri-O-acetyl-glucal, propylene glycol diacetate, ethylene glycol diacetate, monoesters or diesters of 1,2-ethanediol, 1,2-propanediol, 1,3-propanediol, 1,2-butanediol, 1,3-butanediol, 2,3-butanediol, 1,4-butanediol, 1,2-pentanediol, 2,5-pentanediol, 1,6-pentanediol, 1,2-hexanediol, 2,5-hexanediol, or 1,6-hexanediol.

Triacetin, tributyrin, and other esters may serve as acyl donors for peracid formation.

The acyl substrate may comprise propylene glycol diacetate, ethylene glycol diacetate, or ethyl acetate. The acyl substrate may comprise propylene glycol diacetate.

The acyl substrate may comprise an acetylated surfactant.

The acyl substrate may comprise an acetylated polyalkyleneglycol, preferably an acetylated polyethyleneglycol, including an acetylated trifunctional polyethyleneglycol having the following structure, obtainable by acetylating Pluriol A3TE commercially available from BASF.

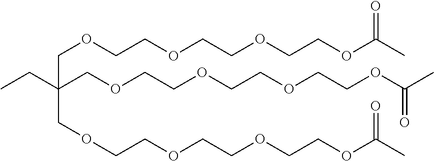 [SMILES: CCC(COCCOCCOCCOC(C)=O)(COCCOCCOCCOC(C)=O)COCCOCCOCCOC(C)=O]

The acyl substrate may include any one or more of the following:

(a) one or more esters having the structure

[X]mR5

wherein
X is an ester group of the formula R6C(O)O; R6 is a C1 to C7 linear, branched or cyclic hydrocarbyl moiety, optionally substituted with a hydroxyl group or C1 to C4 alkoxy group, wherein R6 optionally comprises one or more ether linkages where R6 is C2 to C7;
R5 is a C1 to C6 linear, branched, or cyclic hydrocarbyl moiety optionally substituted with a hydroxyl group, wherein each carbon atom in R5 individually comprises no more than one hydroxyl group or no more than one ester group, and wherein R5 optionally comprises one or more ether linkages;
m is 1 to the number of carbon atoms in R5
said one or more esters having solubility in water of at least 5 ppm at 25.deg.C.; or
(b) one or more glycerides having the structure

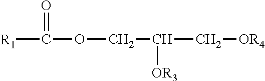

wherein R1 is a C1 to C7 straight chain or branched chain alkyl optionally substituted with an hydroxyl or a C1 to C4 alkoxy group and R3 and R4 are individually H or R1C(O); or
(c) one or more esters of the formula

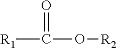

wherein R1 is a C1 to C7 straight chain or branched chain alkyl optionally substituted with an hydroxyl or a C1 to C4 alkoxy group and R2 is a C1 to C10 straight chain or branched chain alkyl, alkenyl, alkynyl, aryl, alkylaryl, alkylheteroaryl, heteroaryl, (CH2CH20)n, or (CH2CH(CH3)-O)nH and n is 1 to 10; or
(d) one or more acetylated monosaccharides, acetylated disaccharides, or acetylated polysaccharides; or
(e) any combination of (a) through (d).

Further, the one or more esters in (a) may comprise the structure, [R6C(O)O]mR5 wherein R5 and R6 are defined as the above and C(O) refers to C═O.

As noted above, suitable substrates may be monovalent (i.e., comprising a single carboxylic acid ester moiety) or plurivalent (i.e., comprising more than one carboxylic acid ester moiety). The amount of substrate used may be adjusted depending on the number carboxylic acid ester moieties in the substrate molecule.

The acyl substrate may be a liquid, which includes viscous liquids and gels. Exemplary liquids are PGDA, triacetin, and other substrates listed herein, which are liquids at the temperature at which an end user is likely to use the present peracid generating system. Liquid substrates are preferably provided in non-aqueous form, or can be added to the same chamber as a very low water or non-aqueous detergent. The acyl substrate may be a solid, which includes gums resulting from hygroscopic solid acyl substrates. Exemplary liquids are 2,2-dimethyl-1,3-propanediol, paranitrophenyl acetate, glucose pentaacetate, and other substrates listed herein, which are solids at the temperature at which an end user is likely to use the present peracid generating system.

The acyl substrate may be provided in a molar excess with respect to the perhydrolase enzyme. The molar ratio of carboxylic acid ester moieties to perhydrolase enzyme may be at least about 100/1, preferably at least about 1000/1, preferably between 2000/1 and 10000/1.

The acyl substrate may be present in the detergent composition at a concentration of 0.05 wt % to 40 wt %, 0.1 wt % to 20 wt %, 0.3 wt % to 10 wt %, or 0.5 wt % to 5 wt % of the detergent formulation. However, preferably the detergent composition is free of any acyl substrate in order to prevent premature peracid generation. Alternatively the detergent composition is free of any acyl substrate other than eventual esters formulated as part of the perfume composition being added to the detergent composition. In the latter, preferably the perfume composition is physically separated from the acyl transferase enzyme, e.g. by formulating them in a separate compartment of a multi-compartment water soluble pouch.

The present invention further provides a fabric bleaching kit which comprises:
(i) A fabric treatment composition comprising an ester containing compound;
(ii) A detergent composition comprising an acyl transferase enzyme and a peroxide source; and
(iii) Instructions for performing a method for fabric treatment comprising the steps of:
   a. providing a fabric comprising an ester containing compound pre-deposited thereon; and
   b. contacting the fabric from step (i) with an aqueous medium comprising an acyl transferase enzyme and a peroxide source, wherein the acyl transferase enzyme causes generation of peracid in situ in the wash liquor.

In use, the fabric treatment composition comprising the ester containing compound is applied to a fabric article and the fabric article is contacted with an aqueous medium prepared by diluting the detergent composition with water, wherein the acyl transferase enzyme causes generation of peracid in situ in the aqueous medium.

The method of the invention may be used in essentially any washing, cleaning and/or fabric treatment methods, including soaking methods, spray-on treatment methods, pre-treatment methods, and methods with rinsing steps for which a separate rinse aid composition may be added.

Further, the invention works across all washing machine cycles ranging from short cycles of 5 minutes to long cycles of 60 minutes, 5 to 40 minutes, 5 to 30 minutes, or 6 to 20 minutes. Specifically, the invention enables rapid formation of peracid in situ within a wash cycle within seconds to provide a minimum cleaning benefit for stain removal at the short cycles. It follows that a higher cleaning efficacy will be seen at longer cycles. A commercial washing machine may be used for the present invention and the volume of commercial washing machine may be 7 to 70 liters, preferably 7 to 40 liters, more preferably 7 to 30 liters, even more preferably 7 to 20 liters.

For example, if used in an automated washing method such as a commercial washing machine, the volume of commercial washing machine may be 7 to 70, preferably 7 to 40, more preferably 7 to 30, even more preferably 7 to 20 liters. The pH of the aqueous medium may be neutral to slightly alkaline, and may be from 6 to 12, 7 to 10, 7 to 9, or 7 to 8.

The detergent composition may be comprised in a water-soluble unit dose article comprising a water-soluble film, preferably a multi-compartment water-soluble unit dose article.

The fabric may be any suitable fabric. The fabric may comprise natural or synthetic materials or a combination thereof. Preferably the fabric may comprise natural fabrics. The fabric may comprise cotton, polycotton, polyester, or a combination thereof. The fabric may comprise cotton. Without wishing to be bound by theory, it is believed that fabrics made of the above materials provide improved pre-deposition of the ester containing compound onto the fabrics and assisted in providing a higher concentration of pre-deposited ester containing compound on the fabric. Specifically, softening esters have a higher affinity towards natural compared to synthetic fibers, and as such a higher amount of an ester compound will be pre-deposited thereon so that more peracid may be formed in situ within the aqueous medium.

The method may further comprise, prior to step (ii), contacting the fabric from step (i) with a soil.

The following examples further illustrate the invention, but are not intended to be limiting thereof.

### EXAMPLES

Generations of a peracid bleaching compound according to the method of the present invention was demonstrated in the following experiment. Equipment and materials used in the experiment are listed in Table 1 below. The aqueous medium is referred to as a “wash liquor” in the Examples below.

TABLE 1
Equipment/Materials

| Component | Example |
|---|---|
| Ester containing compound | Fabric softening active (DiEthylEster Dimethyl Ammonium |
| | Chloride (DEEDMAC)) |
| Ester Solution | Solution of: |
| | 37 milligrams (mg) of Ester containing compound |
| | 3 liters (3000 millitres) of demineralized water |
| Acyl Transferase Enzyme | 3.7% active - Optimase AE 1000 from DuPont |
| Peroxide Source | Percarbonate |
| Detergent Composition | Contents in bottom compartment of Ariel 3-in-1 Pods, as |
| | commercially available in the UK in July 2016 |
| Wash liquor A | Solution of: |
| (Inventive Example) | 2.3 grams (g) of Detergent Composition |
| | 1 liter (1000 millitres) of demineralized water |
| | 350 milligrams (mg) of Peroxide Source |
| | 37 milligrams (mg) of Acyl Transferase Enzyme |
| Wash Liquor B | Solution of: |
| (Comparative Example) | 2.3 grams (g) of Detergent Composition |
| | 1 liter (1000 millitres) of demineralized water |
| Rinse Solution 1 | 3 liters (3000 millitres) of demineralized water |
| Rinse Solution 2 | 3 liters (3000 millitres) of demineralized water |
| Rinse Solution 3 | 3 liters (3000 millitres) of demineralized water |
| Container 1 for Ester Solution | Beaker (Base Diameter of 11 cm) |
| Container 2 for Wash Liquor A | Magnetic Stirrer positioned in the center of the beaker |
| Container 3 for Wash Liquor B | (Magnetic Stirrer: Teflon coated, length 4.5 cm) |
| Container 4 for Rinse Solution 1 | |
| Container 5 for Rinse Solution 2 | Beaker (Base Diameter of 11 cm) |
| Container 6 for Rinse Solution 3 | Metal Blade positioned in the center of the beaker |
| Peracid Indicator | 100 ml of a 10% potassium iodide solution |
| Fabric Swatch A | Cotton terry (size: 30 cm × 30 cm) |
| (Inventive Example) | |
| Fabric Swatch B | Cotton terry (size: 30 cm × 30 cm) |
| (Comparative Example) | |

The experiment is carried out according to the following steps:

### Step 1: Ester Containing Compound Pre-Deposition Step

An ester containing compound is pre-deposited on fabrics (Fabric Swatch A and Fabric Swatch B) by:
(i) Washing Fabric Swatch A and Fabric Swatch B at room temperature (approximately 25 degrees Celsius) for 10 minutes in the Ester Solution
(ii) Mechanically agitating Fabric Swatch A and Fabric Swatch B in the Ester Solution with the magnetic stirrer at a rotation speed setting of highest possible speed without loss of balance of the magnetic stirrer (“Rotation Speed Setting”)
(iii) Removing Fabric Swatch A and Fabric Swatch B from the Ester Solution, and hand squeezing till there is no further water running out from the fabrics
(iv) Rinsing Fabric Swatch A and Fabric Swatch B for 10 minutes at room temperature through stirring of the fabrics in the Rinse Solution 1 using the magnetic stirrer at the above Rotation Speed Setting
(v) Removing Fabric Swatch A and Fabric Swatch B from the Rinse Solution 1, and hand squeezing the fabrics till no water runs out, thereby forming pre-treated Fabric Swatches A, B, wherein the pre-treated Fabric Swatches A, B comprise an ester containing compound pre-deposited thereon
(vi) Air drying the pre-treated Fabric Swatches A, B at room temperature.

### Step 2: Peracid Generation Step

Fabric Swatch A and Fabric Swatch B are treated by:
(i) Washing Fabric Swatch A in Wash Liquor A, and Fabric Swatch B in Wash Liquor B by stirring each of the fabrics with the magnetic stirrer at the above Rotation Speed Setting for 15 minutes at room temperature
(ii) Removing Fabric Swatch A and Fabric Swatch B from the respective Wash Liquors A, B and hand squeezing till no further water running out
(iii) Rinsing Fabric Swatch A in Rinse Solution 2 and Fabric Swatch B in Rinse Solution 3 by stirring separately each of the fabrics with the metal blade for 10 minutes at room temperature
(iv) Adding the Peracid Indicator into each of the Rinse Solution 2 and Rinse Solution 3
(v) Stirring Fabric Swatch A in the Rinse Solution 2 and Fabric Swatch B in the Rinse Solution 3 with the metal blade for 10 minutes at room temperature
(vi) Removing Fabric Swatch A and Fabric Swatch B from the respective Rinse Solutions A, B and hand squeezing the fabrics till no water runs out
(vii) Air drying the Fabric Swatch A and Fabric Swatch B at room temperature.

### Test Results

After performing the above steps (i) and (ii), the L,a,b-values of the Fabric Swatches A, B are measured using a MATLAB software on a digital picture. The results are shown in Table 2 set out below.

TABLE 2
b-value of Inventive and Comparative Examples

| | Wash Liquor | Fabric | b-value |
|---|---|---|---|
| Inventive Example | Wash Liquor A | Fabric Swatch A | 10.40 |
| Comparative Example | Wash Liquor B | Fabric Swatch B | 8.49 |

As shown in Table 2, a significantly higher b-value is observed for the Inventive Example of Fabric Swatch A washed in Wash Liquor A, i.e. the detergent composition comprising percarbonate and acyl transferase compared to the Comparative Example of Fabric Swatch B washed in Wash Liquor B, i.e. the detergent composition without percarbonate and acyl transferase. The higher b-value represents yellowing of the fabric due to presence of iodine (I2) which is indicative of presence of a peracid compound on the fabric at the end of the wash cycle. This is because a peracid compound reacts with potassium iodide to generate iodine (peracid+potassium iodide (KI)->12). Therefore, it can be concluded that the presence of pre-deposited ester softening active on a fabric enabled the generation of peracid in presence of an aqueous medium comprising percarbonate and acyl transferase enzyme.

An example is shown below:

A. A method of treating fabrics comprising the steps of:
Receiving a fabric comprising an ester containing compound pre-deposited thereon; and
(ii) contacting the fabric with an aqueous medium comprising, an acyl transferase enzyme and a peroxide source, wherein the acyl transferase enzyme causes generation of peracid in situ in the aqueous medium.
   B. The method according to A, wherein the ester containing compound is selected from the group consisting of: fabric softening ester compounds, perfume ester compounds and mixtures thereof.
   C. The method according to A or B, wherein the ester containing compound is pre-deposited onto the fabric in a pre-treatment step prior to step (i), wherein the pre-treatment step is selected from the group consisting of:
   spraying a liquid composition comprising the ester containing compound on the fabric through a trigger, aerosol or foam spray device,
   immersing the fabric in a liquid composition comprising the ester containing compound, and
   washing and/or conditioning the fabric in a previous washing machine cycle with a detergent or conditioning composition comprising the ester-containing compound.
      D. The method according to any one of A, B, C or D, wherein the fabric softening ester compound is selected from the group consisting of quaternary ammonium ester compounds, sucrose esters, ester amines, fatty esters, and combinations thereof.
      E. The method according to D, wherein the fabric softening ester compound is selected from the group consisting of quaternary ammonium ester compounds (ester quats) and mixtures thereof.
      F. The method according to F, wherein the fabric softening ester compound is selected from the group consisting of diester quats and mixtures thereof, preferably the diester quat is Diethylester Dimethyl Ammonium Chloride (DEEDMAC).
      G. The method according to any one of A, B, C, D, E, or F, wherein the aqueous medium comprises between 0.01 and 10 ppm of the acyl transferase enzyme.
      H. The method according to any one of A, B, C, D, E, F, or G wherein the peroxide source is selected from the group consisting of hydrogen peroxide, organic or inorganic perhydrate salts, an enzymatic peroxide generating system, and mixtures thereof, preferably an inorganic perhydrate salt, an enzymatic peroxide generating system, and mixtures thereof, more preferably an inorganic perhydrate salt and mixtures thereof, most preferably sodium percarbonate.
      I. The method according to any one of A, B, C, D, E, F, G, or H, wherein the temperature of the aqueous medium is between 20 degrees Celsius to 50 degrees Celsius, preferably between 25 degrees Celsius to 40 degrees Celsius.
      J. The method according to any one of A, B, C, D, E, F, G, H or I, wherein the aqueous medium is prepared by diluting a laundry detergent composition in water, wherein the laundry detergent composition comprises the acyl transferase enzyme, the peroxide source, and less than 1%, preferably less than 0.5%, more preferably less than 0.1%, by weight of the laundry detergent composition of an additional acyl substrate.
      K. The method according to J, wherein the aqueous medium is prepared by diluting a laundry detergent composition in water, wherein the laundry detergent composition comprises the acyl transferase enzyme, the peroxide source and 0.05% to 40% by weight of the laundry detergent composition of an additional acyl substrate, wherein the additional acyl substrate is substantially free of esters found in perfume ester compounds.
      L. The method according to J, wherein the laundry detergent composition comprises 10% to 60% by weight of the laundry detergent composition of a surfactant system comprising an anionic surfactant and optionally a non-ionic surfactant.
      M. The method according to J, wherein the laundry detergent composition comprises: an adjunct material selected from the group consisting of: one or more surfactants selected from the group consisting of: an amphoteric surfactant, a zwitterionic surfactant, a cationic surfactant; one or more cleaning polymers, surface modifying or conditioning polymers and soil suspension polymers; a builder; a chelant; a cleaning enzyme; a brightener agent; and a hueing agent.
      N. The method according to J, wherein the laundry detergent composition is comprised within a water-soluble unit dose article comprising a water-soluble film, wherein the water-soluble unit dose article is a multi-compartment water-soluble unit dose article.
      O. The method according to any one of A to N, wherein the fabric from step (i) is selected from the group consisting of: natural fabrics, synthetic fabrics and a mixture thereof, preferably natural fabrics.
      P. The method according to any one of A to N, further comprising, prior to step (ii), contacting the fabric from step (i) with a soil.
      Q. A fabric treatment kit comprising:
      at least one component selected from: a fabric treatment composition comprising an ester containing compound and a detergent composition comprising an acyl transferase enzyme and a peroxide source; and instructions for performing a method for fabric treatment comprising the steps of:
(i) providing a fabric comprising an ester containing compound pre-deposited thereon; and
(ii) contacting he fabric from step (i) with an aqueous medium comprising an acyl transferase enzyme and a peroxide source, wherein the acyl transferase enzyme causes generation of peracid in situ in the aqueous medium.
   R. Use of an ester containing compound pre-deposited on a fabric as a bleach activator in a laundry wash process for in-situ generation of peracids.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of treating fabrics comprising the steps of:
(i) providing a fabric comprising an ester containing compound pre-deposited thereon; and
(ii) contacting the fabric with an aqueous medium comprising an acyl transferase enzyme and a peroxide source, wherein the acyl transferase enzyme causes generation of peracid in situ in the aqueous medium.

2. The method according to claim 1, wherein the ester containing compound is selected from the group consisting of: fabric softening ester compounds, perfume ester compounds and mixtures thereof.

3. The method according to claim 1, wherein the ester containing compound is deposited on the fabric in a pre-treatment step selected from the group consisting of:
spraying a liquid composition comprising the ester containing compound on the fabric through a trigger, aerosol or foam spray device,
immersing the fabric in a liquid composition comprising the ester containing compound, and
washing and/or conditioning the fabric in a previous washing machine cycle with a detergent composition comprising the ester-containing compound.

4. The method according to claim 3, wherein the pre-treatment step comprises washing the fabric in a previous washing machine cycle with a detergent composition comprising the ester-containing compound, wherein the fabric softening ester compound is selected from the group consisting of quaternary ammonium ester compounds, sucrose esters, ester amines, fatty esters, and combinations thereof.

5. The method according to claim 4, wherein the fabric softening ester compound is selected from the group consisting of diester quats and mixtures thereof.

6. The method according to claim 5, wherein the diester quat is Diethylester Dimethyl Ammonium Chloride (DEEDMAC).

7. The method according to claim 1, wherein the aqueous medium comprises between 0.05 and 10 ppm of the acyl transferase enzyme.

8. The method according to claim 1, wherein the peroxide source is selected from the group consisting of hydrogen peroxide, organic or inorganic perhydrate salts, an enzymatic peroxide generating system, and mixtures thereof.

9. The method according to claim 8, wherein the peroxide source is selected from the group consisting of: an inorganic perhydrate salt, an enzymatic peroxide generating system, and mixtures thereof.

10. The method according to claim 1, wherein the temperature of the aqueous medium is between 20 degrees Celsius to 50 degrees Celsius.

11. The method according to claim 1, wherein the aqueous medium is prepared by diluting a laundry detergent composition in water, wherein the laundry detergent composition comprises the acyl transferase enzyme, the peroxide source, and less than 1%, by weight of the laundry detergent composition of an additional acyl substrate.

12. The method according to claim 1, wherein the aqueous medium is prepared by diluting a laundry detergent composition in water wherein the laundry detergent composition comprises the acyl transferase enzyme, the peroxide source, and 0.05% to 40% by weight of the laundry detergent composition of an additional acyl substrate, wherein the additional acyl substrate is substantially free of esters found in perfume ester compounds.

13. The method according to claim 11, wherein the laundry detergent composition comprises 10% to 60% by weight of the laundry detergent composition of a surfactant system, wherein the surfactant system comprises an anionic surfactant and optionally a non-ionic surfactant.

14. The method according to claim 11, wherein the laundry detergent composition comprises an adjunct material selected from the group consisting of: one or more surfactants selected from the group consisting of: an amphoteric surfactant, a zwitterionic surfactant, a cationic surfactant; one or more cleaning polymers, surface modifying or conditioning polymers and soil suspension polymers; a builder; a chelant; cleaning enzymes; a brightener agent; and a hueing agent.

15. The method according to claim 1, wherein the fabric is selected from the group consisting of: natural fabrics, synthetic fabrics and a mixture thereof, preferably natural fabrics.

16. A fabric treatment kit comprising:
at least one component selected from: a fabric treatment composition comprising an ester containing compound and a detergent composition comprising an acyl transferase enzyme and a peroxide source; and
instructions for performing a method comprising the steps of:
(i) providing a fabric comprising an ester containing compound pre-deposited thereon; and
(ii) contacting the fabric with an aqueous medium comprising an acyl transferase enzyme and a peroxide source, wherein the acyl transferase enzyme causes generation of peracid in situ in the aqueous medium.

17. Use of an ester containing compound pre-deposited on a fabric as a bleach activator in a laundry wash process for in-situ generation of peracids.


SEQUENCE LISTING (8 sequences)

SEQ ID NO: 1 - protein, 216 aa, Mycobacterium smegmatis
MAKRILCFGDSLTWGWVPVEDGAPTERFAPDVRWTGVLAQQLGADFEVIEEGLSARTTNIDDPTDPRLNGASYLPSCLATHLPLDLVIIMLGTNDTKAYFRRTPLDIALGMSVLVTQVLTSAGGVGTTYPAPKVLVVSPPPLAPMPHPWFQLIFEGGEQKTTELARVYSALASFMKVPFFDAGSVISTDGVDGIHFTEANNRDLGVALAEQVRSLL

SEQ ID NO: 2 - protein, 216 aa, Mycobacterium smegmatis
MAKRILCFGDSLTWGWVPVEDGAPTERFAPDVRWTGVLAQQLGADFEVIEEGLVARTTNIDDPTDPRLNGASYLPSCLATHLPLDLVIIMLGTNDTKAYFRRTPLDIALGMSVLVTQVLTSAGGVGTTYPAPKVLVVSPPPLAPMPHPWFQLIFEGGEQKTTELARVYSALASFMKVPFFDAGSVISTDGVDGIHFTEANNRDLGVALAEQVRSLL

SEQ ID NO: 3 - protein, 325 aa, Thermotoga neapolitana
MAFFDMPLEELKKYRPERYEEKDFDEFWRETLKESEGFPLDPVFEKVDFHLKTVETYDVTFSGYRGQRIKGWLLVPKLAEEKLPCVVQYIGYNGGRGFPHDWLFWPSMGYICFVMDTRGQGSGWMKGDTPDYPEGPVDPQYPGFMTRGILDPGTYYYRRVFVDAVRAVEAAISFPRVDSRKVVVAGGSQGGGIALAVSALSNRVKALLCDVPFLCHFRRAVQLVDTHPYVEITNFLKTHRDKEEIVFRTLSYFDGVNFAARAKVPALFSVGLMDTICPPSTVFAAYNHYAGPKEIRIYPYNNHEGGGSFQAIEQVKFLKRLFEEG

SEQ ID NO: 4 - protein, 325 aa, Thermotoga maritima
MAFFDLPLEELKKYRPERYEEKDFDEFWEETLAESEKFPLDPVFERMESHLKTVEAYDVTFSGYRGQRIKGWLLVPKLEEEKLPCVVQYIGYNGGRGFPHDWLFWPSMGYICFVMDTRGQGSGWLKGDTPDYPEGPVDPQYPGFMTRGILDPRTYYYRRVFTDAVRAVEAAASFPQVDQERIVIAGGSQGGGIALAVSALSKKAKALLCDVPFLCHFRRAVQLVDTHPYAEITNFLKTHRDKEEIVFRTLSYFDGVNFAARAKIPALFSVGLMDNICPPSTVFAAYNYYAGPKEIRIYPYNNHEGGGSFQAVEQVKFLKKLFEKG

SEQ ID NO: 5 - protein, 326 aa, Thermotoga lettingae
MVYFDMPLEDLRKYLPQRYEEKDFDDFWKQTIHETRGYFQEPILKKVDFYLQNVETFDVTFSGYRGQKIKGWLILPKFRNGKLPCVVEFVGYGGGRGFPYDWLLWSAAGYAHFIMDTRGQGSNWMKGDTPDYEDNPSDPQYPGFLTKGVLNPETYYYRRVFMDAFMAVETISQLEQIDSQTIILSGASQGGGIALAVSALSSKVMALLCDVPFLCHYKRAVQITDSMPYAEITRYCKTHIDKIQTVFRTLSYFDGVNFAARAKCPALFSVGLMDDICPPSTVFAAYNYYAGEKDIRIYPYNNHEGGGSFHTLEKLKFVKKTISMRE

SEQ ID NO: 6 - protein, 325 aa, Thermotoga petrophila
MAFFDLPLEELKKYRPERYEEKDFDEFWEGTLAENEKFPLDPVFERMESHLKTVEAYDVTFSGYMGQRIKGWLLVPKLEEEKLPCVVQYIGYNGGRGFPHDWLFWPSMGYICFVMDTRGQGSGWMKGDTPDYPEDPVDPQYPGFMTRGILDPRTYYYRRVFTDAVRAVEAAASFPRVDHERIVIAGGSQGGGIALAVSALSKKAKALLCDVPFLCHFRRAVQLVDTHPYAEITNFLKTHRDKEEIVFRTLSYFDGVNFAVRAKIPALFSVGLMDNICPPSTVFAAYNHYAGPKEIRIYPYNNHEGGGSFQAIEQVKFLKRLFEKG

SEQ ID NO: 7 - protein, 325 aa, Thermotoga sp. RQ2
MAFFDLPLEELKKYRPERYEEKDFDEFWKETLAESEKFPLDPVFERMESHLKTVEVYDVTFSGYRGQRIKGWLLVPKLEEEKLPCVVQYIGYNGGRGFPHDWLFWPSMGYICFVMDTRGQGSGWLKGDTPDYPEDPVDPQYPGFMTRGILDPRTYYYRRVFTDAVRAVEAAASFPRVDHERIVIAGGSQGGGIALAVSALSKKAKALLCDVPFLCHFRRAVQLVDTHPYAEITNFLKTHRDKEEIVFRTLSYFDGVNFAVRAKIPALFSVGLMDNICPPSTVFAAYNHYAGPKEIRIYPYNNHEGGGSFQAIEQVKFLKRLFEKG

SEQ ID NO: 8 - protein, 329 aa, Thermotoga sp. RQ2
MALFDMPLEKLRSYLPDRYEEEDFDLFWKETLEESRKFPLDPIFERVDYLLENVEVYDVTFSGYRGQRIKAWLILPVVKKEERLPCIVEFIGYRGGRGFPFDWLFWSSAGYAHFVMDTRGQGTSRVKGDTPDYCDEPINPQFPGFMTRGILDPRTYYYRRVFTDAVRAVETASSFPGIDPERIAVVGTSQGGGIALAVAALSEIPKALVSNVPFLCHFRRAVQITDNAPYSEIVNYLKVHRDKEEIVFRTLSYFDGVNFAARAKIPALFSVALMDKTCPPSTVFAAYNHYAGPKEIKVYPFNEHEGGESFQRMEELRFMKRILKGEFKA